(19) United States
(12) Patent Application Publication
(10) Pub. No.: US 2004/0233626 A1
(43) Pub. Date: Nov. 25, 2004

(54) Portable computer

(76) Inventors: Wei-Min Chang, Taipei (TW); Gwo-Chyuan Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/843,116

(22) Filed: May 11, 2004

(30) Foreign Application Priority Data
May 20, 2003 (CN) 92209188

(51) Int. Cl. G06F 1/16

(52) U.S. Cl. 361/683; 361/680

(57) ABSTRACT

A portable computer. The portable computer includes a main body having a depression. A first input module and a second input module are optionally disposed therein, wherein the first input module can be attached to the depression by a first frame, and the second input module thereto by a second frame.

### BACKGROUND OF THE INVENTION

1. Field of the Invention

The present invention relates to a portable computer, and in particular to a portable computer in which input modules are exchangeable.

2. Description of the Related Art

Conventionally, input modules of a portable computer include a keyboard and touch pad or track point, wherein the keyboard has 88/89 keys compatible with the portable computer. Because of limited space, some optional and additional input modules must be connected through serial ports, USB, or other ports of the portable computer.

Thus, users may have difficulty achieving complete input capability or must connect special external input modules.

Hence, there is a need for a portable computer whose input modules can be easily exchanged.

### SUMMARY OF THE INVENTION

Accordingly, an object of the invention is to provide a portable computer whose input modules can be easily exchanged.

The portable computer includes a main body having a depression. Input modules are optionally disposed therein, wherein a first input module can be attached to the depression by a first frame, and a second input module can be attached to the depression by a second frame. The first frame has a partition separating the depression into first and second regions. The first input module includes a first sub-module and a second sub-module, respectively disposed in the first and second regions.

According to the present invention, the input modules are easily exchanged and attached to the portable computer using standard connections on the frames to enable related functionality thereof. Different input modules attached to the portable computer provide enhanced ease of use. For manufacturers, the present invention provides flexibility of design, easily meeting a variety of user needs.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the first embodiment of the present invention;

FIG. 2 shows the input module in the first embodiment of the present invention being exchanged;

FIGS. 3a-3b show the second embodiment of the present invention; and

FIG. 4 shows the third embodiment of the present invention.

### DETAILED DESCRIPTION OF THE INVENTION

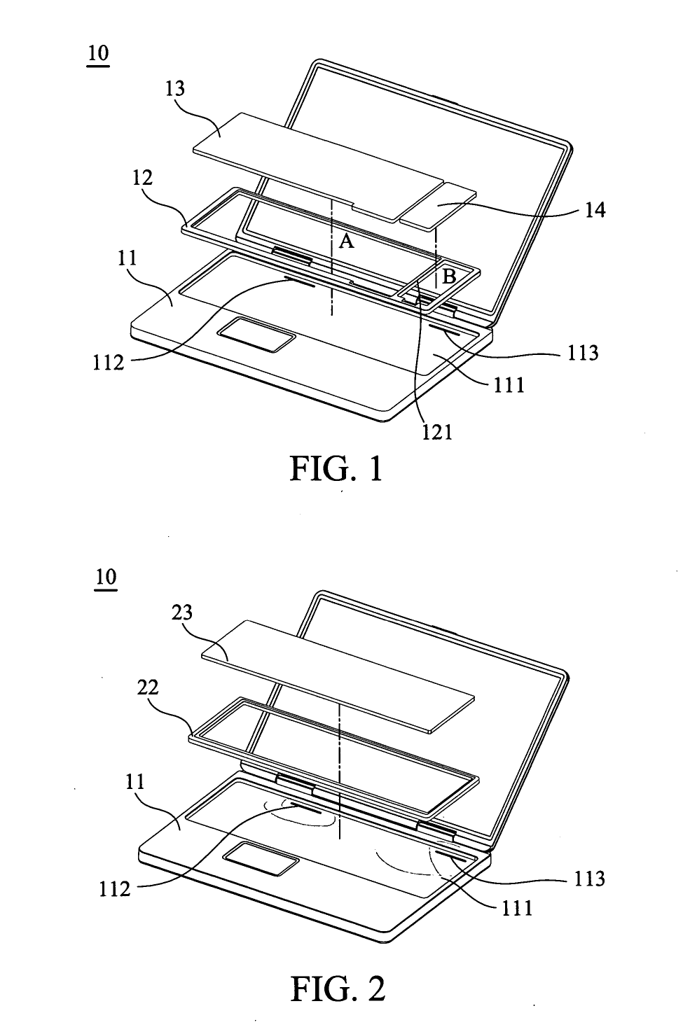

FIG. 1 shows the first embodiment of the present invention. A main body 11 of a portable computer 10 includes a depression 111 receiving a first frame 12 having a partition 121. The first frame 12 is removably disposed in the depression 111 of the main body, and the partition 121 of the first frame 12 separates the depression 111 into a first region A and a second region B. A first input module includes a first sub-module 13 and a second sub-module 14, wherein the first sub-module 13 is removably attached to the first region A through the first frame 12, and the second sub-module 14 is removably attached to the second region B through the first frame 12. In the first embodiment, the first frame 12 is tenon joined on the depression 111, and the first sub-module 13 and the second sub-module 14 are respectively tenon joined the first and the second regions.

As shown in FIG. 1, the first sub-module 13 can be a portable-type keyboard. The second sub-module 14 can be a numeric keypad module, biometric recognition device, tablet device, or wireless communication module. In addition, a first connector 112 and a second connector 113 are disposed on the main body 11 and respectively connect to the first sub-module 13 and the second sub-module 14. As a result, the first connector 112 can be a keyboard module connector and the second connector 113 compatible the wireless communication modules described above.

FIG. 2 shows the input module in the first embodiment of the present invention being exchanged. When the first input module is exchanged with a second input module, the first frame 12, the first sub-module 13 and the second sub-module 14, are removed simultaneously. After removing the first frame 12, the first sub-module 13, and the second sub-module 14, a second frame 22 is removably disposed in the depression 111 of the main body 11 of the portable computer 10. A second input module 23 is removably disposed on the main body 11 through the second frame 22. Thus, the portable computer 10 presents typical portable computer functionality having only a keyboard module. The connector 112 disposed on the main body can also electrically connect to the second input module 23. The second input module 23 is a conventional desktop-type keyboard module.

The second frame 22 is tenon joined the depression 111, and the second input module 23 is tenon joined in the depression 111 by the second frame 11. When the portable computer 10 is equipped with a large display, such as 17″, the main body 11 provides sufficient space to deploy a conventional desktop-type keyboard module as the second input module 23.

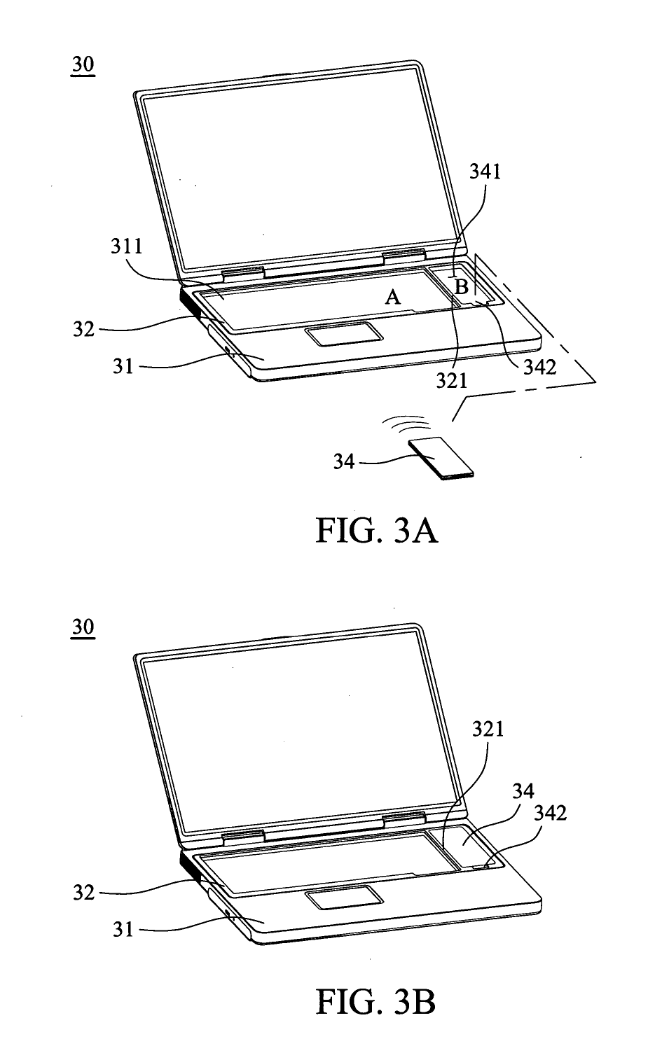

FIGS. 3a-3b show the second embodiment of the present invention. A main body 31 of a portable computer 30 has a depression 311, with a third frame 32 having a partition 321 removably disposed therein, wherein the partition separates the depression 311 into a first region A and a second region B. Similar to the first embodiment described above, a first sub-module (not shown in FIGS. 3a-3b), for example a keyboard module, is also disposed in the first region A. The second region B can contain a second sub-module 34, with a second connector 341 disposed therein. When the second sub-module 34 is deployed in the second region B, the second connector 341 connects the second sub-module 34 and the main body 31.

As shown in FIGS. 3a-3b, the second sub-module 34 is a remote control, and the second connector 341 is a remote control connector. FIG. 3a shows that the remote control 34 is drawn out from the second region B. FIG. 3b shows the remote control 34 deployed in the second region B. The third frame 32 is tenon joined on the depression 311. The remote control 34 is tenon joined on the second region B of the depression 311 by the third frame 32. The third frame 32 defines a recessed portion 342 for easy removal of the remote control 34.

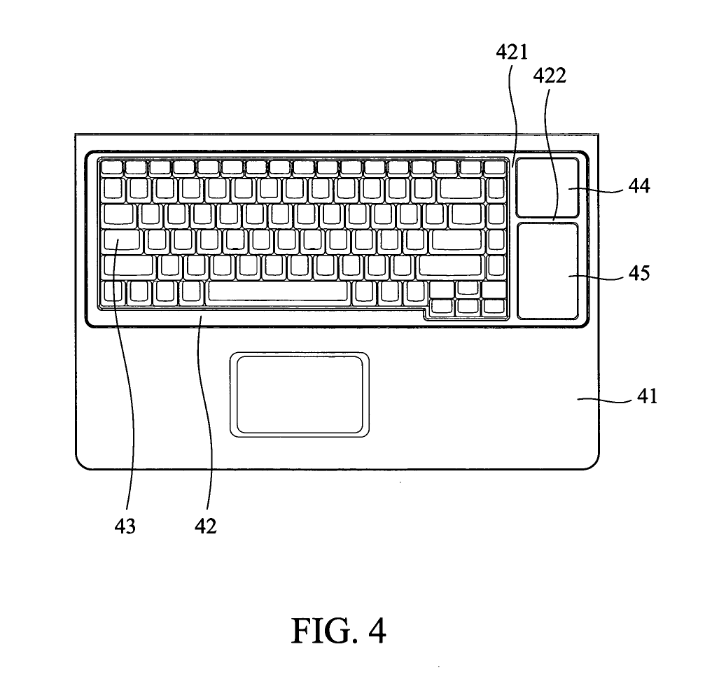

FIG. 4 shows the third embodiment of the present invention. A fourth frame 42 having partitions 421 and 422 is disposed on a main body 41 of a portable computer. The input module of the portable includes a first sub-module 43, a second sub-module 44 and a third sub-module 45 each providing different input functions, and the second sub-module 44 and the third sub-module 45 can be a numeric keypad module, biometric recognition device, tablet device, wireless communication module, a remote control, or others.

According to the present invention, the input modules are easily exchanged and attached to the portable computer using standard connections on the frames to enable related functionality thereof. In addition, different input modules directly attached to the portable computer provide enhanced ease of use. For manufacturers, the present invention provides flexibility of design, easily meeting a variety of user needs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable computer, comprising:
a main body having a depression;
a first frame having a partition;
a first input module optionally disposed on the main body through the first frame and having a first sub-module and a second sub-module, wherein the depression is separated into first and second regions by the partition, the first sub-module disposed in the first region, and the second sub-module disposed in the second region;
a second frame; and
a second input module optionally disposed in the depression through the second frame.

2. The portable computer as claimed in claim 1, further comprising a connector disposed in the depression and electrically connected to the first input module and the main body.

3. The portable computer as claimed in claim 1, further comprising a connector disposed in the depression and electrically connected to the second input module and the main body.

4. The portable computer as claimed in claim 1, wherein the first frame is engaged with the depression.

5. The portable computer as claimed in claim 1, wherein the second frame is engaged with the depression.

6. The portable computer as claimed in claim 1, wherein the first input module is tenon joined on the depression by the first frame.

7. The portable computer as claimed in claim 1, wherein the second input module is tenon joined on the depression by the second frame.

8. The portable computer as claimed in claim 1, wherein the second input module comprising a desktop-type keyboard module.

9. The portable computer as claimed in claim 1, wherein the first sub-module comprises a portable-type keyboard module.

10. The portable computer as claimed in claim 1, wherein the second sub-module is a numeric keypad module, biometric recognition device, tablet device, wireless communication module, or remote control.

11. The portable computer as claimed in claim 1, wherein the first sub-module is tenon joined in the first region of the depression, and the second sub-module is tenon joined in the second region of the depression.

12. The portable computer as claimed in claim 1, wherein the main body comprising:
a first connector disposed in the first region of the depression to connect the first sub-module to the main body; and
a second connector disposed in the second region of the depression to connect the second sub-module to the main body.

13. A portable computer, comprising:
a main body having a depression;
a keyboard connector disposed in the depression;
a sub-module connector disposed in the depression;
a frame removably disposed in the depression, having a partition separating the depression into first and second regions, the keyboard connector disposed in the first region, and the sub-module connector disposed in the second region;
a portable-type keyboard module removably disposed in the first region of the depression through frame and electrically connected to the main body using the keyboard connector; and
a sub-module removably disposed in the second region of the depression through the frame and electrically connected to the main body using the sub-module connector.

14. The portable computer as claimed in claim 13, wherein the sub-module is a numeric keypad module, biometric recognition device, tablet device, wireless communication module, or remote control.

15. The portable computer as claimed in claim 13, wherein the frame is tenon joined in the depression.

16. The portable computer as claimed in claim 13, wherein the keyboard module is tenon joined in the first region of the depression, and the sub-module is tenon joined in the second region of the depression

17. A portable computer, comprising:
a main body;
a frame disposed on the main body, with a partition separating the main body into first and second regions; and
an input module disposed on the main body through the frame, wherein the input module has a keyboard and a remote control, the keyboard disposed in the first region, and the remote control removably disposed in the second region.

18. The portable computer as claimed in claim 17, further comprising a keyboard connector disposed on the main body.

19. The portable computer as claimed in claim 17, further comprising a remote control connector disposed on the main body.

20. The portable computer as claimed in claim 17, wherein the main body has a depression, with the frame and the input module disposed therein.
